(19) United States
(12) Patent Application Publication
(10) Pub. No.: US 2012/0102946 A1
(43) Pub. Date: May 3, 2012

(54) AFTER-TREATMENT COOLING WITH COMBUSTION FEEDBACK

(75) Inventors: THOMAS LAROSE, JR., Redford, MI (US); MICHAEL V. TAYLOR, Wolverine Lake, MI (US)

(73) Assignee: GM GLOBAL TECHNOLOGY OPERATIONS, INC., Detroit, MI (US)

(21) Appl. No.: 12/938,416

(22) Filed: Nov. 3, 2010

(51) Int. Cl. F02D 23/00

(52) U.S. Cl. 60/602

(57) ABSTRACT

A method of operating an engine having a turbo charger includes sensing a temperature of a flow of exhaust gas from the engine, determining if the temperature of the exhaust gas is greater than an upper temperature threshold, sensing a cylinder pressure within the cylinders of the engine with a pressure sensor, determining if the cylinder pressure is greater than an upper pressure limit, sensing a boost provided by the turbo charger, determining if the boost is greater than a maximum boost limit, and adjusting the operation of the engine when the temperature of the exhaust gas entering the turbo charger is greater than an upper temperature threshold and the cylinder pressure is less than the upper pressure limit to reduce the temperature of the exhaust gas entering the turbo charger to a temperature below the upper temperature threshold.

### TECHNICAL FIELD

The invention generally relates to a method of operating an internal combustion engine having a turbo charger powered by a flow of exhaust gas and an after-treatment system that treats exhaust gas of the engine with an oxidation catalyst.

### BACKGROUND

Internal combustion engines, and diesel engines particularly, often include a turbo charger and an after-treatment system for treating the exhaust gas from the engine. The turbo charger includes a compressor that is driven by the flow of exhaust gas to compress combustion air flowing into the cylinders of the engine prior to combustion. The exhaust gas flows through the turbo charger to the after-treatment system. The after-treatment system uses an oxidation catalyst to heat the exhaust gas to a desired temperature to burn soot from the exhaust gas. The oxidation catalyst oxidizes unburned hydrocarbons in the exhaust gas to produce heat.

When the engine is operating under heavy loads, the temperature of the exhaust gas increases. If the temperature of the exhaust gas reaches or exceeds a component limit, i.e., an upper temperature threshold, various components of the engine, the turbo charger and/or the oxidation catalyst for example, may be damaged.

### SUMMARY

A method of operating an internal combustion engine having a turbo charger is provided. The method includes monitoring an inlet temperature of a flow of exhaust gas entering the turbo charger. The method further includes sensing a cylinder pressure within a cylinder of the engine, and determining if the cylinder pressure is greater than an upper pressure limit of the engine. The method further includes adjusting the operation of the engine when the temperature of the exhaust gas entering the turbo charger is greater than an upper temperature threshold and the cylinder pressure is less than the upper pressure limit. The operation of the engine is adjusted to reduce the temperature of the exhaust gas entering the turbo charger to a temperature below the upper temperature threshold.

A method of operating an internal combustion engine having a turbo charger is also provided. The method includes monitoring an inlet temperature of a flow of exhaust gas entering the turbo charger. The method further includes sensing a cylinder pressure within a cylinder of the engine, and determining if the cylinder pressure is greater than an upper pressure limit of the engine. The method further includes continuously sensing a turbine speed of the turbo charger, and determining if the sensed turbine speed of the turbo charger is greater than a maximum speed of the turbo charger. The method further includes continuously sensing a turbine inlet pressure of the turbo charger, and determining if the turbine inlet pressure of the turbo charger is greater than a maximum inlet pressure limit. The method further includes adjusting the operation of the engine when the temperature of the exhaust gas entering the turbo charger is greater than an upper temperature threshold and the cylinder pressure is less than the upper pressure limit. The engine is adjusted to reduce the temperature of the exhaust gas entering the turbo charger to a temperature below the upper temperature threshold. Adjusting the operation of the engine to reduce the temperature of the exhaust gas includes one of increasing the boost from the turbo charger when the turbine inlet pressure is less than the maximum inlet pressure limit and the sensed turbine speed of the turbo charger is less than the maximum speed of the turbo charger, and advancing the main timing of the engine when the turbine inlet pressure is equal to or greater than the maximum inlet pressure limit and the sensed turbine speed of the turbo charger is equal to or greater than the maximum speed of the turbo charger.

Accordingly, when the cylinder pressure is less than the upper pressure limit, the disclosed method reduces the temperature of the flow of exhaust gas from the engine by increasing the boost from the turbo charger when the turbine inlet pressure is less than the maximum inlet pressure limit, or advancing the main timing of the engine when the turbine inlet pressure is equal to or greater than the maximum inlet pressure limit. Increasing the boost from the turbo charger and/or increasing the main timing of the engine increases the pressure within the cylinder and reduces the temperature of the exhaust gas from the engine. Accordingly, the disclosed method cools the flow of exhaust gas when the cylinder pressure is less than the upper pressure limit to protect various engine components, such as the turbo charger and an oxidation catalyst of an exhaust gas after-treatment system, and not damage other components from excessive heat.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a flow chart showing a method of operating an internal combustion engine having a turbo charger.

### DETAILED DESCRIPTION

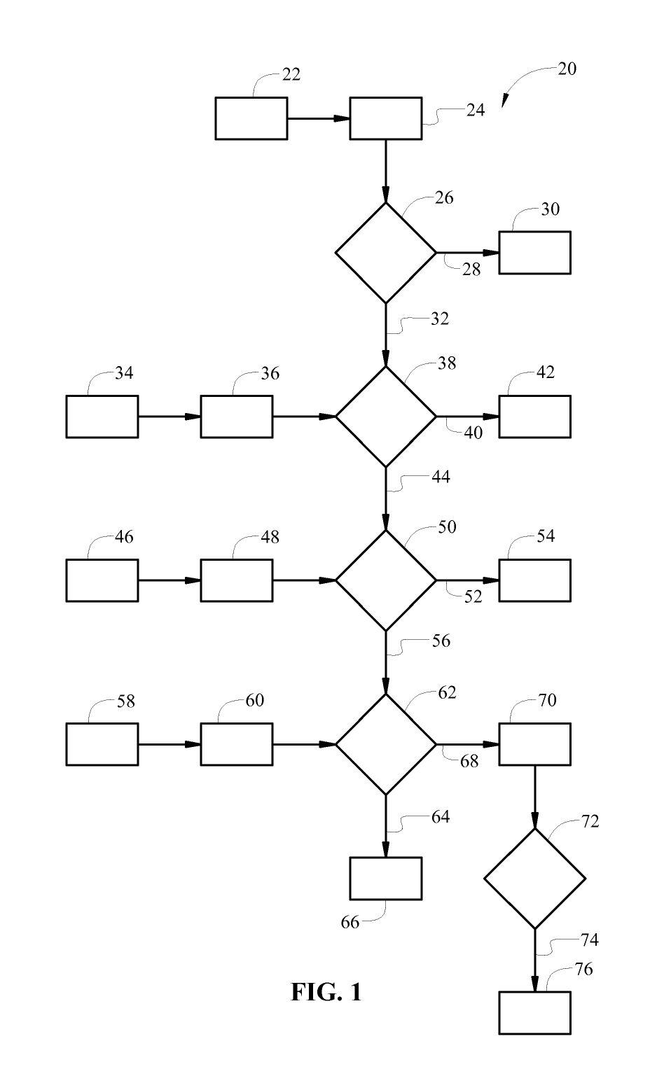

Referring to FIG. 1, a method of operating an internal combustion engine is shown generally at 20. The engine may include, but is not limited to, a diesel engine. The engine includes a turbo charger. The exhaust gas from the engine flows through the turbo charger and drives a compressor in the turbo charger, which provides boost to the engine, i.e., compresses the combustion air entering cylinders of the engine prior to combustion. The engine may further include an after-treatment system for treating the exhaust gas from the engine with an oxidation catalyst. Once the exhaust gas exists the turbo charger, the exhaust gas flows through the after-treatment system, where the oxidation catalyst oxidizes the unburned hydrocarbons in the exhaust to burn any soot in the exhaust gas.

The method includes defining an upper temperature threshold for the exhaust gas, block 22. Various components of the engine, including but not limited to the turbo charger and the oxidation catalyst, may be damaged if exposed to excessive heat from the exhaust gas. The upper temperature threshold is the upper temperature limit for the exhaust gas. The upper temperature threshold is defined to be equal to a level that is slightly below a temperature that may damage any of the various engine components. Accordingly, by maintaining the temperature of the exhaust gas at or below the upper temperature threshold, any potential damage to the various engine components from exposure to excessive heat from the exhaust gas may be avoided.

The method further includes monitoring an inlet temperature of a flow of exhaust gas upstream of, i.e., entering, the turbo charger, block 24. Monitoring an inlet temperature of the flow of exhaust gas may include sensing the temperature of the exhaust gas, and determining if the temperature of the exhaust gas is greater than the upper temperature threshold, block 26. The temperature of the exhaust gas may be sensed in any suitable manner, including but not limited to sensing the temperature of the exhaust gas with a temperature sensor. A computer, such as but not limited to an engine control unit, may continuously compare the sensed temperature of the exhaust gas to the upper temperature threshold to determine if the temperature of the exhaust gas is greater than or less than the upper temperature threshold.

If the temperature of the exhaust gas is not greater than the upper temperature threshold, i.e., the temperature of the exhaust gas is equal to or less than the upper temperature threshold, indicated at 28, then the method may further include maintaining current operation of the engine, block 30. Because the temperature of the exhaust gas is below the level that may damage the various engine components, there is no need to modify the operation of the engine to reduce the temperature of the exhaust gas.

If the temperature of the exhaust gas is greater than the upper temperature threshold, indicated at 32, then the method may further include defining an upper pressure limit of a cylinder of the engine, block 34. The upper pressure limit of the cylinder is the greatest pressure the cylinders of the engine are designed to operate at. The upper pressure limit is set at a level to avoid potential damage to engine components from excessive pressure. As such, the upper pressure limit varies with different engine designs. For example, the upper pressure limit of the cylinders may be defined as equal to one hundred fifty (150) bar. It should be appreciated that the upper pressure limit may be defined to equal any suitable pressure limit.

The method further includes sensing a cylinder pressure within the cylinder of the engine, block 36. Sensing the cylinder pressure within the cylinder of the engine may further be defined as continuously sensing the cylinder pressure within each cylinder of the engine. The engine may include a pressure sensor disposed at one or more cylinders of the engine for sensing the cylinder pressure within one or more of the cylinders. The pressure sensor may include, but is not limited to, a glow plug pressure sensor.

The method further includes determining if the cylinder pressure is greater than the upper pressure limit of the engine, block 38. A computer, such as but not limited to the engine control unit, compares the sensed cylinder pressure of each cylinder of the engine to the upper pressure limit to determine if any of the cylinder pressures within any of the cylinders are greater than the upper threshold limit.

If the cylinder pressure of any of the cylinders is equal to or greater than the upper pressure limit, indicated at 40, then the method may further include applying a peak power limitation, block 42. The peak power limitation limits the power output of the engine. The engine control unit may adjust the operation of the engine to prevent the power output of the engine from rising above the peak power limitation, thereby controlling the cylinder pressure to maintain the cylinder pressure below the upper pressure limit, or if necessary, reduce the cylinder pressure too or below the upper pressure limit.

If the sensed cylinder pressure from all of the cylinders of the engine is not greater than the upper pressure limit, i.e., the cylinder pressure from all of the cylinders of the engine are less than the upper pressure limit, indicated at 44, then the method may further include defining a maximum speed of the turbo charger, block 46. The maximum speed of the turbo charger is slightly less than the upper rotational turbine speed that the turbo charger may safely operate at. Accordingly, maintaining the operation of the turbo charger at or below the maximum speed of the turbo charger may avoid damage to the turbo charger.

The method further includes continuously sensing the turbine speed of the turbo charger, block 48. The turbine speed of the turbo charger may be sensed in any suitable manner, including but not limited to a speed sensor. The method further includes comparing the sensed turbine speed of the turbo charger to the maximum speed of the turbo charger to determine if the sensed turbine speed of the turbo charger is greater than the maximum speed of the turbo charger, block 50. A computer, such as but not limited to the engine control unit, may analyze and compare the sensed turbine speed of the turbo charger to the maximum speed of the turbo charger to determine if the sensed turbine speed of the turbo charger is greater than, equal to or less than the maximum speed of the turbo charger.

If the turbine speed of the turbo charger is equal to or greater than the maximum speed of the turbo charger, indicated at 52, then the method may include adjusting the main timing of the engine to reduce the temperature of the exhaust gas entering the turbo charger to a temperature below the upper threshold, block 54. Advancing the main timing of the engine decreases the exhaust gas temperature because more heat is released in the combustion chamber, which creates more pressure in the cylinder, and is thus transferred to the piston to produce work. Retarding the main timing of the engine burns the gasses in the combustion chamber at a later point, so less is transferred as work into the piston, and more is transferred into the exhaust system as heat. Accordingly, if the engine is operating inefficiently to increase the temperature of the exhaust gas, such as when operating in a regeneration mode for regenerating a particulate filter of the exhaust system, increasing the main timing increases the efficiency of the engine. In the regeneration mode, the main timing is retarded to operate the engine inefficiently to generate more heat in the exhaust. When the engine is operating in the regeneration mode, increasing the main timing for the engine, i.e., advancing the main timing of the engine, increases the efficiency of the engine. Accordingly, for a given torque output of the engine, less energy is required, thereby producing less heat.

If the turbine speed of the turbo charger is less than the maximum speed of the turbo charger, indicated at 56, then the method may further include defining a maximum inlet pressure limit of the turbo charger, block 58. The maximum inlet pressure limit is the upper limit of the turbine inlet pressure that the turbo charger may safely operate at without damaging one or more various engine components. The maximum inlet pressure limit is set at a level that is below a turbine inlet pressure level that may damage various engine components, or cause the cylinder pressure to increase above the upper pressure limit.

The method further includes continuously sensing the turbine inlet pressure of the turbo charger, block 60. The turbine inlet pressure may be sensed in any suitable manner, including but not limited to with a pressure sensor. The method further includes determining if the sensed turbine inlet pressure of the turbo charger is greater than the maximum inlet pressure limit, block 62. A computer, such as but not limited to the engine control unit, compares the sensed turbine inlet pressure from the turbo charger to the maximum inlet pressure limit to determine if the turbine inlet pressure is less than or greater than the maximum inlet pressure limit.

If the temperature of the exhaust gas entering the turbo charger is greater than the upper temperature threshold, the turbine speed of the turbo charger is less than the maximum speed of the turbo charger, and the current turbine inlet pressure is equal to or greater than the maximum inlet pressure limit, indicated at 64, then the method further includes adjusting the operation of the engine to reduce the temperature of the exhaust gas entering the turbo charger to a temperature below the upper temperature threshold. When the turbine inlet pressure is equal to or greater than the maximum inlet pressure limit, adjusting the operation of the engine to reduce the temperature of the exhaust gas includes increasing the main timing of the engine, block 66. As described above, increasing the main timing of the engine is achieved by advancing the main timing of the engine to make the engine operate more efficiently.

If the temperature of the exhaust gas entering the turbo charger is greater than the upper temperature threshold, the turbine speed of the turbo charger is less than the maximum speed of the turbo charger, and the current turbine inlet pressure is less than the maximum inlet pressure limit, indicated at 68, then adjusting the operation of the engine to reduce the temperature of the exhaust gas includes increasing the boost from the turbo charger, block 70. Increasing the boost from the turbo charger further compresses the combustion air supplied to the cylinders prior to combustion. Therefore, the increased boost increases the amount of air in the cylinders that is heated during combustion. Because more air must be heated during combustion, the temperature of the exhaust gas is lower.

Once the boost has been increased, the temperature of the exhaust gas entering the turbo charger is compared to the upper temperature threshold, block 72. If the temperature of the exhaust gas is still greater than the upper temperature threshold and the turbine inlet pressure has increased to the maximum inlet pressure limit, indicated at 74, then adjusting the operation of the engine to reduce the temperature of the exhaust gas includes increasing the main timing of the engine, block 76. As described above, increasing the main timing of the engine is achieved by advancing the main timing of the engine to make the engine operate more efficiently.

While the best modes for carrying out the invention have been described in detail, those familiar with the art to which this invention relates will recognize various alternative designs and embodiments for practicing the invention within the scope of the appended claims.

1. A method of operating an internal combustion engine having a turbo charger, the method comprising:
monitoring an inlet temperature of a flow of exhaust gas entering the turbo charger;
sensing a cylinder pressure within a cylinder of the engine;
determining if the cylinder pressure is greater than an upper pressure limit of the engine; and
adjusting the operation of the engine when the temperature of the exhaust gas entering the turbo charger is greater than an upper temperature threshold and the cylinder pressure is less than the upper pressure limit to reduce the temperature of the exhaust gas entering the turbo charger to a temperature below the upper temperature threshold.

2. A method as set forth in claim 1 wherein sensing the cylinder pressure within a cylinder of the engine is further defined as continuously sensing the cylinder pressure within a cylinder of the engine.

3. A method as set forth in claim 2 wherein sensing a cylinder pressure within a cylinder of the engine includes sensing a cylinder pressure within each cylinder of the engine.

4. A method as set forth in claim 3 wherein the engine includes a pressure sensor disposed at each cylinder, and wherein sensing a cylinder pressure within each cylinder is further defined as sensing a cylinder pressure within each cylinder with the pressure sensor disposed at each cylinder.

5. A method as set forth in claim 4 wherein the pressure sensor includes a glow plug pressure sensor.

6. A method as set forth in claim 1 further comprising maintaining current operation of the engine when the temperature of the exhaust gas is less than the upper temperature threshold.

7. A method as set forth in claim 1 further comprising applying a peak power limitation when a sensed cylinder pressure within the cylinder is equal to or greater than the upper pressure limit.

8. A method as set forth in claim 1 further comprising continuously sensing a turbine inlet pressure of the turbo charger.

9. A method as set forth in claim 8 further comprising determining if the turbine inlet pressure of the turbo charger is greater than a maximum inlet pressure limit.

10. A method as set forth in claim 9 wherein adjusting the operation of the engine to reduce the temperature of the exhaust gas includes increasing the boost from the turbo charger when the turbine inlet pressure is less than the maximum inlet pressure limit.

11. A method as set forth in claim 10 wherein adjusting the operation of the engine to reduce the temperature of the exhaust gas includes increasing the main timing of the engine when the turbine inlet pressure is equal to or greater than the maximum inlet pressure limit.

12. A method as set forth in claim 9 wherein adjusting the operation of the engine to reduce the temperature of the exhaust gas includes increasing the main timing of the engine when the turbine inlet pressure is equal to or greater than the maximum inlet pressure limit.

13. A method as set forth in claim 1 wherein monitoring an inlet temperature of a flow of exhaust gas includes sensing the temperature of the exhaust gas.

14. A method as set forth in claim 13 wherein monitoring an inlet temperature of a flow of exhaust gas includes determining if the temperature of the exhaust gas is greater than an upper temperature threshold.

15. A method as set forth in claim 1 further comprising defining an upper pressure limit of the cylinder.

16. A method as set forth in claim 15 wherein defining an upper pressure limit of the cylinder is further defined as defining an upper pressure limit of the cylinder equal to approximately one hundred fifty (150) bar.

17. A method as set forth in claim 1 further comprising defining an upper temperature threshold for the exhaust gas.

18. A method of operating an internal combustion engine having a turbo charger, the method comprising:
monitoring an inlet temperature of a flow of exhaust gas entering the turbo charger;
sensing a cylinder pressure within a cylinder of the engine;
determining if the cylinder pressure is greater than an upper pressure limit of the engine;
continuously sensing a turbine speed of the turbo charger;
determining if the sensed turbine speed of the turbo charger is greater than a maximum speed of the turbo charger;
continuously sensing a turbine inlet pressure of the turbo charger;
determining if the turbine inlet pressure of the turbo charger is greater than a maximum inlet pressure limit;
adjusting the operation of the engine when the temperature of the exhaust gas entering the turbo charger is greater than an upper temperature threshold and the cylinder pressure is less than the upper pressure limit to reduce the temperature of the exhaust gas entering the turbo charger to a temperature below the upper temperature threshold, wherein adjusting the operation of the engine to reduce the temperature of the exhaust gas includes one of increasing the boost from the turbo charger when the turbine inlet pressure is less than the maximum inlet pressure limit and the sensed turbine speed of the turbo charger is less than the maximum speed of the turbo charger, and increasing the main timing of the engine when the turbine inlet pressure is equal to or greater than the maximum inlet pressure limit and the sensed turbine speed of the turbo charger is equal to or greater than the maximum speed of the turbo charger.

19. A method as set forth in claim 18 wherein the engine includes a pressure sensor disposed at least one cylinder, and wherein sensing a cylinder pressure within a cylinder is further defined as sensing a cylinder pressure within the at least one cylinder with the pressure sensor disposed at the at least one cylinder.

20. A method as set forth in claim 18 further comprising maintaining current operation of the engine when the temperature of the exhaust gas is less than the upper temperature threshold.
